(19) United States
(12) Patent Application Publication
(10) Pub. No.: US 2026/0104066 A1
(43) Pub. Date: Apr. 16, 2026

(54) Clip for Reducing Metal-on-Metal Contact and Noise in Hook-Based Applications

(71) Applicant: Grant Douglas Olsen, Phoenix, AZ (US)

(72) Inventor: Grant Douglas Olsen, Phoenix, AZ (US)

(21) Appl. No.: 18/912,436

(22) Filed: Oct. 10, 2024

(51) Int. Cl. F16B 2/20; A45F 3/24; A63B 69/20

(52) U.S. Cl. CPC F16B 2/20; A63B 69/305; A45F 3/24

(57) ABSTRACT

The present invention relates to a clip system designed to reduce friction, noise, and wear caused by metal-on-metal contact in various applications. The clip can be attached to curved hardware such as hooks, swivels, or carabiners and is sacrificial in nature, meaning it can be easily replaced when worn out, extending the life of the primary hardware. Made from soft rubber or plastic, the clip also provides protection from environmental elements such as moisture and corrosion. With applications in sports, recreation, and marine settings, the clip's design prevents vertical and horizontal shifting, includes adhesive mechanisms for secure placement, and is suitable for use on different surfaces and hardware configurations. This innovation offers a cost-effective solution to minimize mechanical wear and noise while improving durability and versatility in various metal-based systems.

### BACKGROUND OF THE INVENTION

### Field of Invention

The present invention relates to the field of protective devices and components used in hardware applications, specifically focusing on a removable clip designed to reduce friction, noise, and metal-on-metal contact in situations where hooks, carabiners, swivels, or other curved hardware interfaces are commonly used. The invention is applicable in various industries, including sports and recreation and marine applications, and automotive towing. It serves as a sacrificial barrier that prolongs the life of metal components, prevents squeaking that occurs when two metal pieces are in contact and moving, while offering the option for easy replacement of this sacrificial component and not the entire hardware assembly.

### BRIEF SUMMARY OF THE INVENTION

The present invention is a specialized clip designed to reduce friction, noise, and wear caused by metal-on-metal contact in various hardware applications, such as hooks, carabiners, swivels, and other curved attachments. The clip acts as a sacrificial component that can be easily replaced when worn out, extending the life of the hardware it protects. The clip's unique rounded and curved design ensures a secure fit on a variety of metal surfaces, preventing unwanted movement or shifting. It can be used across different industries, including sports (such as hanging heavy bags on a swivel and/or a hook), marine applications (such as where a piece of hardware such as a pully may be connected to another piece of rigging such as a hook), or even in leisure environments (such as might occur when a carabiner clips onto an eye-bolt in some hammock applications). In brief, this clip offers a durable and versatile solution for reducing wear and enhancing performance in dynamic environments. The clip can be produced through methods such as 3D printing or plastic injection molding and, if need be, metal versions could be cast.

### BRIEF DESCRIPTION OF THE FIGURES

FIG. 1: Top view of the swivel clamp, illustrating the overall structure and dimensions of the clip designed to reduce friction between hardware components.

FIG. 2: Bottom view of the swivel clamp, showcasing the attachment mechanism and how the clip fits securely onto the underlying metal component.

FIG. 3: Side view of the swivel clamp, highlighting the rounded curvature that prevents horizontal and vertical movement during use.

FIG. 4: Front view of the swivel clamp, showing the protective design intended to minimize metal-on-metal contact.

FIG. 5: Swivel front view, focusing on the clip's ability to reduce friction and noise at connection points.

FIG. 6: Perspective view of the swivel clamp, providing a complete visualization of the clip's design and its interaction with metal hardware.

FIG. 7: Top view of the J hook design, displaying the specific configuration for hooks and its compatibility with various hardware.

FIG. 8: Bottom view of the J hook, detailing how the clip securely attaches to the base of the hook for stability.

FIG. 9: Side view of the J hook design, illustrating the curvature that reduces unwanted movement and noise.

FIG. 10: Front view of the J hook design, emphasizing the protective layer that eliminates direct metal contact..

FIG. 11: Perspective view of the J hook design, offering a complete depiction of the clip's overall structure and its application in different environments.

FIG. 12: Flowchart outlining the process of using the clip, from attachment to replacement, demonstrating its role in reducing friction and extending the lifespan of metal hardware.

FIG. 13: Illustration of typical prior art connectors used in a heavy bag linkage demonstrating the need for the technology of the present of invention.

FIG. 14: Illustration of heavy bag linkage according to an embodiment of the present invention.

### DETAILED DESCRIPTION

The present invention is an innovative clip designed to reduce friction and noise in various applications where metal-on-metal contact occurs. It is sacrificial in nature, meaning it serves as a replaceable barrier that extends the life of the hardware it is used with. The invention is particularly useful in applications involving hooks, swivels, and carabiners, which are commonly used in sports, recreation, leisure, and marine environments. The clip is designed to eliminate or significantly reduce the wear and tear on the hardware that would otherwise be caused by direct metal contact, while also mitigating the noise that results from such interactions.

### Design and Features

The clip is crafted to fit securely onto a variety of metal hardware, such as hooks and swivels, by providing a rounded and curved saddle that aligns with the shape of the hardware. This design ensures the clip stays in place during movement, preventing horizontal and vertical shifting. The upward curvature of the saddle helps lock the clip into place, reducing the possibility of slippage, even when subjected to the forces associated with swinging or rotating objects, such as a heavy bag or a hammock. Additionally, the clip is equipped with “legs” that wrap around the hardware, depending on the material used for construction. For more rigid applications, the legs may simply rest against the top and sides of the hardware, while in more flexible materials, the legs may fully wrap around, offering enhanced stability and further reducing movement.

A notable feature of this clip is its replaceable nature. Unlike traditional hardware that becomes defective when its protective layer wears down, this clip can be easily replaced without needing to discard the entire hardware setup. In cases where metal hooks or other components are coated in vinyl or rubber to reduce noise and/or friction, the coating will deteriorate with wear and the protective function will no longer be present. However, the sacrificial design of this clip allows users to replace the worn-out clip while maintaining the structural integrity of the metal hardware. This not only reduces the cost of replacement but also extends the overall lifespan of the equipment.

### Material and Construction

The clip can be produced using a variety of materials, depending on the intended use and environment. While the primary construction material is envisioned as a plastic that can be 3D printed or plastic-injection molded, other materials such as soft rubber could also be used, either alone or in conjunction with a harder material (e.g., plastic), Especially in applications where additional protection from mechanical vibration is required using rubber underneath the plastic may be effective. If used externally, a rubber coating may provide cushioning and reduce chatter/rattle. However such an application would not be designed for abrasion from continuous movement due to wear of materials such as rubber, meaning it would serve more effectively as a protective cover than as a high-durability component in settings with constant rubbing or friction.

In some cases, the clip may be affixed to the hardware using an adhesive. This method is particularly useful in applications where complete immobility of the clip is desired. Adhesives like glue or double-sided adhesive tape could be employed to hold the clip in place, allowing for easy replacement when necessary. This feature is advantageous in settings where even minimal vertical or horizontal movement of the hardware would be problematic.

### Applications

The primary target market for this invention includes athletes who use heavy bags, as well as those in sports and recreational activities where heavy equipment is suspended from hooks or swivels. However, the potential applications extend far beyond sports. The clip could also be used in marine settings, where metal hooks and swivels are common, or in any environment where metal-on-metal contact leads to undesirable friction and noise.

Beyond wear created by friction alone, the separation of two different types of metals may also have an impact on the weakening of components. For example, carabiners are often made out of aluminum and may be clipped to a stainless steel hook, swivel, link, etc.. Especially for these two types of metals (aluminum and stainless steel) a process referred to as Galvanic Corrosion may occur, weakening the aluminum component. In such contexts, the benefit of the clip extends beyond premature wear due to friction, or excessive noise created, to one of safety.

Another potential application is in the suspension of hammocks. In such a setup, metal hooks or swivels may be used to connect the hammock to its support. Over time, friction between the metal components can weaken the hardware and generate noise. The clip serves as a protective layer, reducing friction and noise, while also extending the life of the metal components.

In addition to recreational uses, this clip is also highly applicable in industrial settings where hooks and swivels are used to lift or suspend heavy equipment. By eliminating metal-on-metal contact, the clip helps protect expensive machinery from wear and tear, while also ensuring a quieter operation.

### Flow of Use

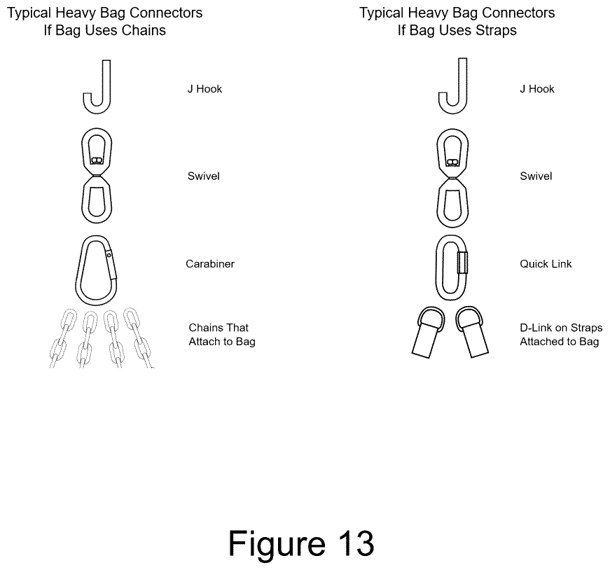

The flowchart in FIG. 13 provides a step-by-step illustration of how the clip is used in practice. First, the user identifies the metal hardware to be protected, such as a hook or swivel. The clip is then selected based on the size and shape of the hardware, ensuring a snug fit. Once the clip is attached, it can be secured in place with or without adhesive, depending on the intended use. The hardware is then used as normal, with the clip providing protection from wear and noise. Over time, as the clip experiences wear, it can be easily removed and replaced, ensuring the metal hardware remains intact and functional.

### Benefits

The primary benefit of this invention is the protection it provides to existing hardware. By serving as a sacrificial component, the clip absorbs the wear that would otherwise damage the metal hardware, thereby extending the life of the equipment. This is especially useful in applications where replacing the entire hardware would be costly or inconvenient. Additionally, the clip significantly reduces noise, which is a common issue in settings where metal components are in motion.

The clip's versatility also sets it apart from other protective solutions. It can be used in a wide variety of applications, from sports and recreation to industrial and marine settings. Its easy installation and replacement make it a practical solution for reducing wear and noise in any environment where metal-on-metal contact occurs.

Furthermore, the ability to affix the clip with adhesive offers an additional level of stability for applications where even slight movement is undesirable. This feature, combined with the option to use different materials for the clip, ensures that the invention can be customized to meet the specific needs of any given application.

This invention provides an efficient and cost-effective solution for reducing friction and noise caused by metal-on-metal contact. Its sacrificial nature extends the life of the hardware it is used with, while its easy replacement ensures that equipment remains functional for longer periods. With applications ranging from sports and recreation to industrial and marine environments, this clip offers a versatile solution for protecting metal components and reducing noise in a wide variety of settings.

### DETAILED DESCRIPTION OF FIGURES

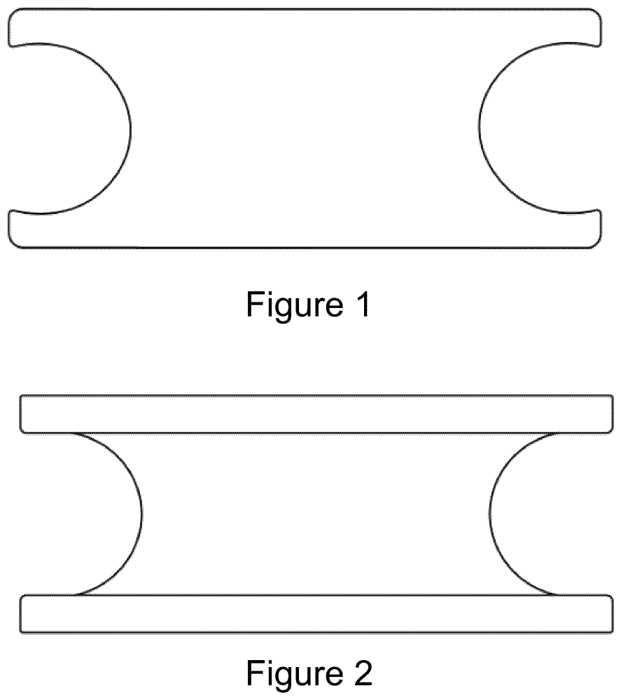

FIG. 1 shows the top view of the swivel clamp, detailing how it is mounted onto the hook. The figure highlights the placement of the clip along the top surface, where it is rounded to ensure stability on curved hardware, preventing unwanted movement.

FIG. 2 provides a bottom view of the swivel clamp, showcasing the paw print design on the bottom surface. This feature serves as an aesthetic addition, as well as a functional grip point, preventing slippage on metal surfaces during movement.

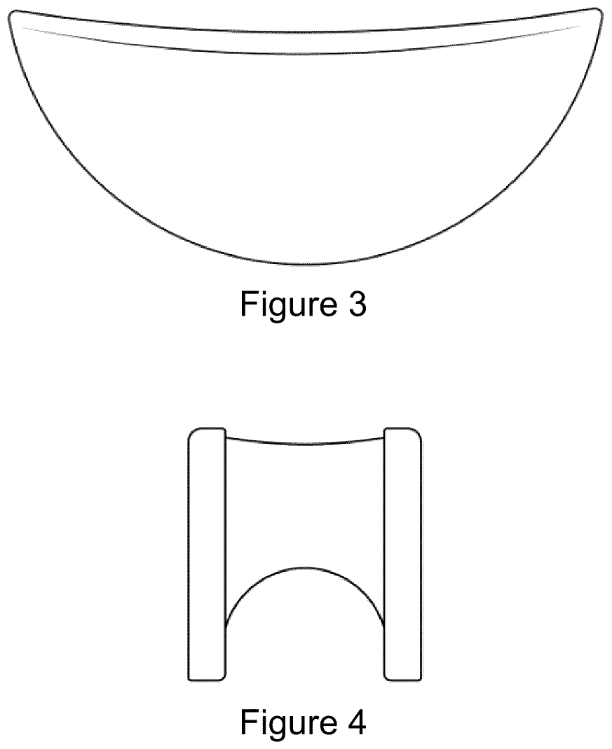

FIG. 3 illustrates a side view of the swivel clamp, focusing on the retractable mechanism. The figure details how the clip can be adjusted to fit various sizes of hardware, such as hooks or carabiners. It demonstrates the versatility of the clip when applied to different tools or structures.

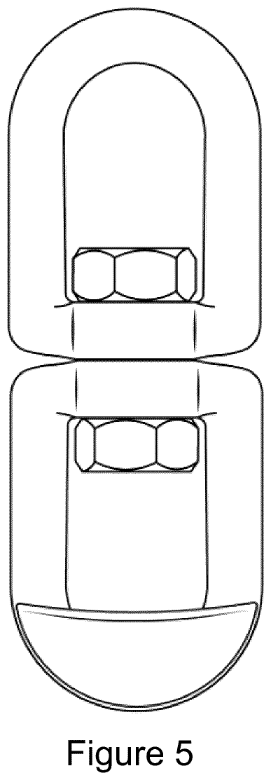

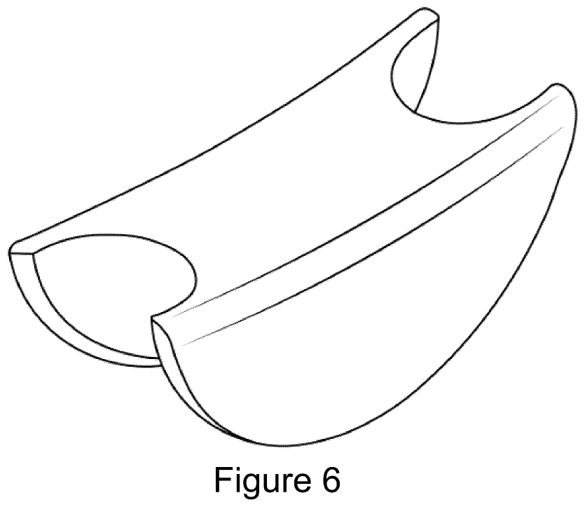

FIG. 4 displays the front view of the swivel clamp, showing the symmetry of the design. This figure emphasizes the uniform distribution of weight across the clip, ensuring that it remains centered on the hardware and does not shift due to imbalance during movement.

FIG. 5 shows the front view of the swivel section of the clamp, highlighting how the mechanism connects with the primary hook and allows for full 360-degree movement. The figure demonstrates the importance of the swivel feature, which allows the clip to rotate smoothly while preventing metal-on-metal contact.

FIG. 6 presents a perspective view of the entire swivel clamp assembly, showing the overall structure and arrangement of the clip, hook, and swivel components. This figure emphasizes the ergonomic design of the product, ensuring ease of use and efficient installation onto various hardware components.

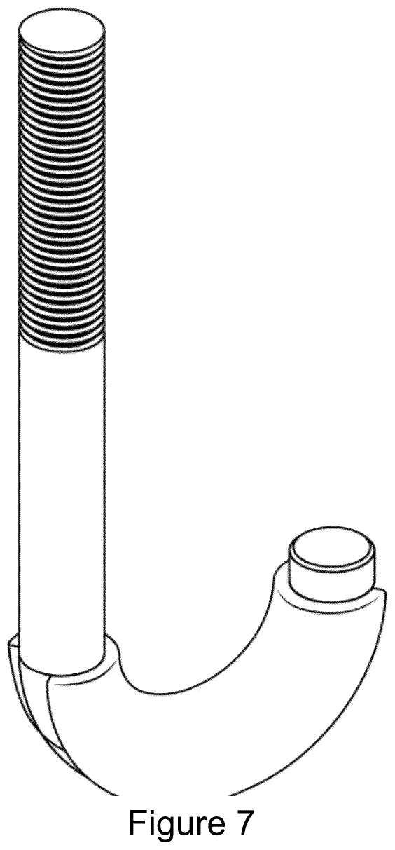

FIG. 7 depicts the perspective J view of the J-hook design, where the clip is fitted onto a J-shaped hook. The figure shows how the rounded design of the clip conforms to the curvature of the J-hook, ensuring a snug fit while allowing for movement and reducing friction.

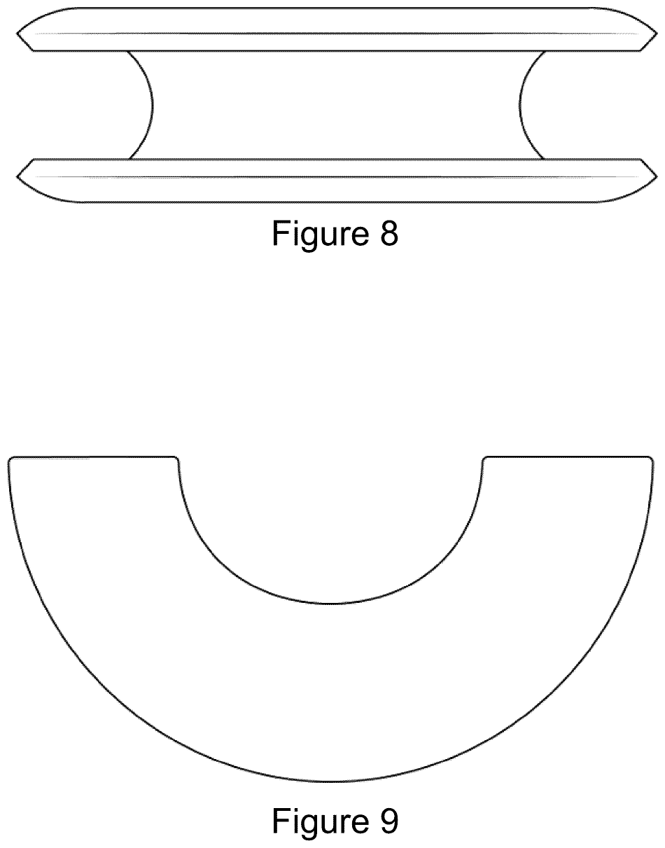

FIG. 8 illustrates the bottom view of the J-hook assembly, once again highlighting the paw print design at the base of the clip. This design ensures grip and prevents the clip from slipping or moving when attached to curved surfaces.

FIG. 9 provides a side view of the J-hook design, showing how the legs of the clip can either rest against or wrap around the underside of the hook, depending on the material used. This figure demonstrates how the clip adjusts to prevent vertical and horizontal movement.

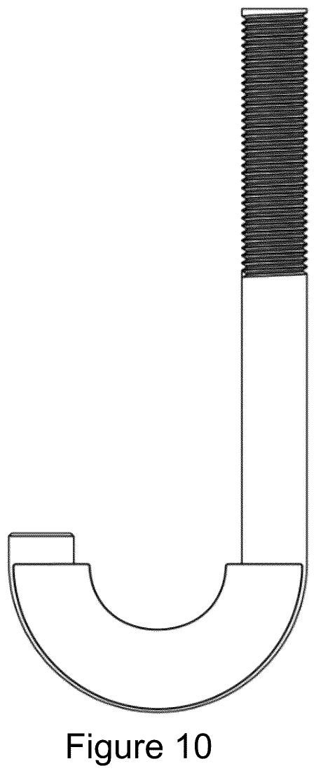

FIG. 10 showcases the side view of the J-hook clip, focusing on the adhesive points where the clip can be affixed to the hook for a more secure fit. The figure also shows the upward curvature of the clip, preventing the clip from sliding off during use.

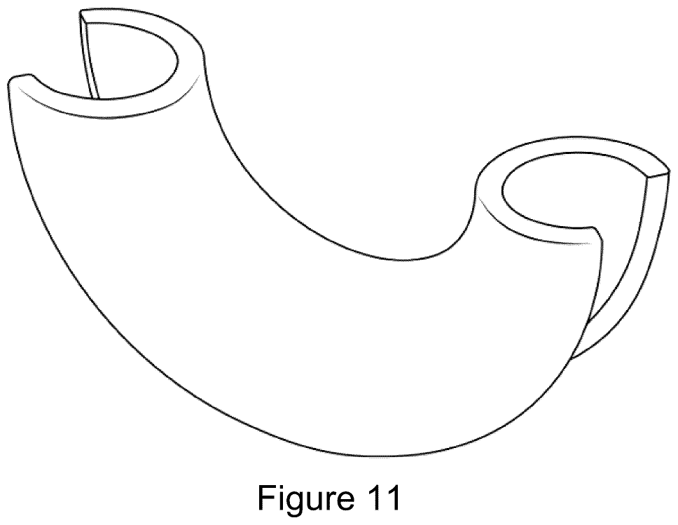

FIG. 11 presents a perspective view of the entire J-hook assembly, showing how the clip fits onto the hook and how it reduces friction during use. This view emphasizes the flexibility of the clip's design, allowing it to be applied to various types of hooks or hardware.

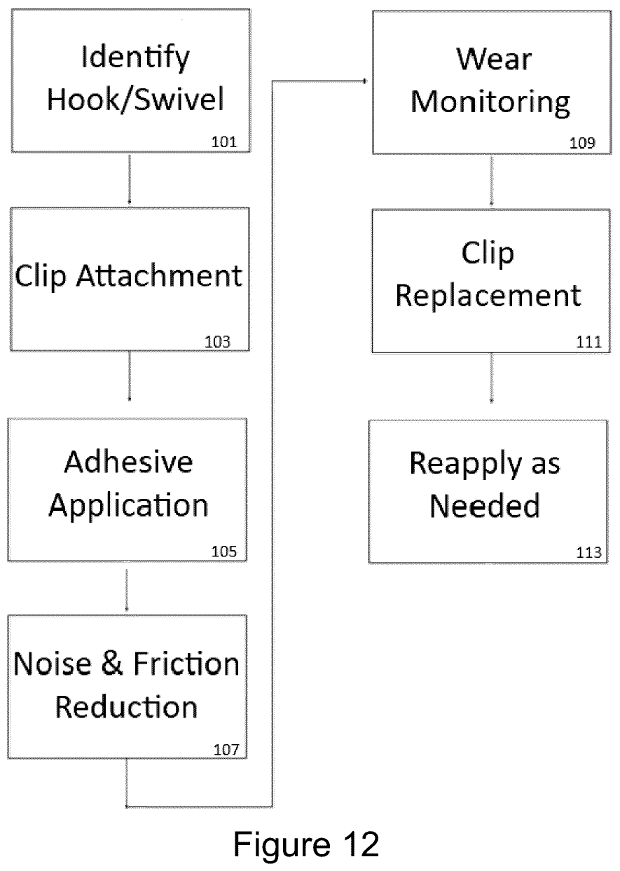

FIG. 12 shows a flowchart detailing the steps involved in using the clip with a piece of metal hardware. The flowchart includes steps for selecting the correct size of clip, attaching it to the hardware, and securing it in place, either through adhesive or friction fit, to reduce noise and extend the lifespan of the hardware.

FIG. 12.101: Determine the type of hardware (hook, swivel, carabiner, etc.) where the clip will be applied.

FIG. 12.103: Attach the clip onto the curved hardware, ensuring it fits securely around the metal.

FIG. 12.105: If necessary, apply adhesive (glue or tape) to further secure the clip and reduce movement.

FIG. 12.107: Clip serves to eliminate metal-on-metal noise and friction by acting as a buffer.

FIG. 12.109: Monitor the clip for signs of wear and tear as it acts as the sacrificial component.

FIG. 12.111: When worn out, easily remove and replace the clip without needing to replace the main hardware.

FIG. 12.113: Repeat the process when necessary to ensure continued protection and functionality.

FIG. 13 is an illustration of typical prior art connectors used in a heavy bag linkage demonstrating the need for the technology of the present of invention. There are a multitude of metal-on-metal contact points which result in friction, wear, failure, and noise.

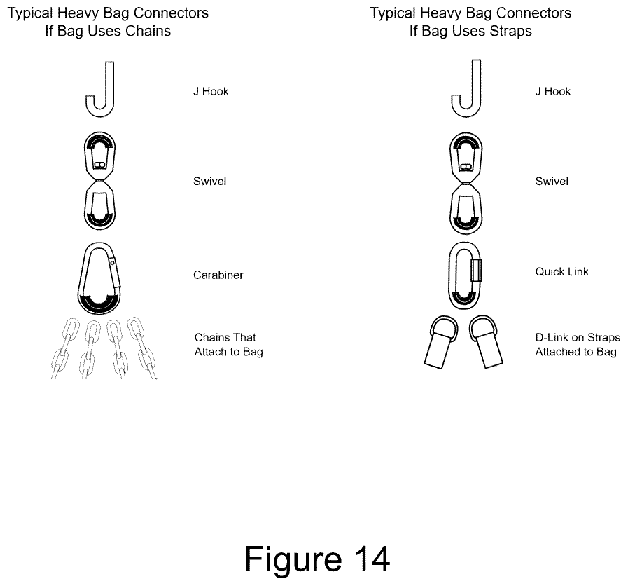

FIG. 14 is an illustration of heavy bag linkage with friction from metal-on-metal contact eliminated by embodiments of the present invention. One of the applications of the present invention is in hanging heavy bags on hooks. Traditionally, heavy bags have had two types of mechanisms to connect with the bag: (1) chains; and, (2) straps with D-Rings. In both of these cases it is typically the case that these attach to a metal swivel via a carabiner (chains) or quick-link (for D-Rings). This swivel is attached to a hook. In either context, there are multiple metal-metal surfaces coming in contact in the linkage. At each metal to metal interface, the friction created will lead to wear on the metal parts, noise, and irreversible weakening and damage to the metal parts (e.g., deep groove formed in a carabiner). By attaching this clip to the hook, metal-on-metal contact is eliminated, and the clip absorbs the wear instead.

What is claimed is:

1. A clip for reducing friction and noise on metal hardware, comprising:
a. a rounded base configured to attach to a curved metal surface;
b. a sacrificial component that minimizes metal-on-metal contact;
c. a soft rubber or plastic material designed to protect the hardware from environmental elements while reducing noise and friction between moving parts.

2. The clip of claim 1, further comprising a retractable pole mechanism that adjusts to fit various sizes of hooks, carabiners, and other hardware.

3. The clip of claim 1, wherein the base includes a paw print design on the bottom surface, providing additional grip and preventing slippage on different surfaces.

4. The clip of claim 1, wherein the clip includes a saddle that is rounded and curved upward, preventing horizontal and vertical shifting on the hardware.

5. The clip of claim 1, wherein the clip further comprises an adhesive mechanism, allowing for secure attachment to the metal hardware while allowing for easy replacement when worn.

6. A method for reducing metal-on-metal contact, comprising:
a. attaching the clip described in claim 1 to a metal hook or other curved hardware;
b. ensuring that the sacrificial component acts as a barrier between the metal surfaces, reducing noise, friction, and wear;
c. replacing the clip when the sacrificial component wears out, thereby extending the lifespan of the primary hardware.

7. The clip of claim 1, wherein the clip is affixed to a J-hook design, featuring a wrapping mechanism around the underside of the hook, which further reduces vertical shifting and enhances stability.

8. The clip of claim 1, wherein the sacrificial component is designed to be flexible enough to fit different metal hardware configurations without deforming, and wherein the clip is made from a material durable enough to withstand repeated use in marine, sports, or recreational applications.

9. A system for protecting metal hardware from environmental damage, comprising the clip of claim 1, wherein the rubber or plastic sacrificial component provides protection against moisture, corrosion, and mechanical wear.

10. The clip of claim 1, wherein the clip is designed to be lightweight and easy to install, providing an efficient and cost-effective solution for minimizing friction, wear, and noise in metal-to-metal applications.
